(19) United States
(12) Patent Application Publication
(10) Pub. No.: US 2026/0121689 A1
(43) Pub. Date: Apr. 30, 2026

(54) SYSTEM AND METHOD FOR CBF FRAME EXCHANGE

(71) Applicant: NXP USA, Inc., AUSTIN, TX (US)

(72) Inventors: Liwen Chu, San Ramon, CA (US); Rui Cao, Sunnyvale, CA (US); Hari Ram Balakrishnan, Chennai (IN); Hongyuan Zhang, Fremont, CA (US); Sudhir Srinivasa, Los Gatos, CA (US); Huizhao Wang, San Jose, CA (US)

(21) Appl. No.: 19/371,955

(22) Filed: Oct. 28, 2025

Related U.S. Application Data
(60) Provisional application No. 63/754,011, filed on Feb. 5, 2025.
(60) Provisional application No. 63/757,271, filed on Feb. 11, 2025.
(60) Provisional application No. 63/762,285, filed on Feb. 24, 2025.
(60) Provisional application No. 63/775,896, filed on Mar. 21, 2025.
(60) Provisional application No. 63/817,008, filed on Jun. 3, 2025.
(60) Provisional application No. 63/821,274, filed on Jun. 10, 2025.

(30) Foreign Application Priority Data
Oct. 28, 2024 (IN) 202441082051
Nov. 11, 2024 (IN) 202441086609

(51) Int. Cl. H04B 7/024; H04W 56/00

(52) U.S. Cl. CPC H04B 7/024; H04W 56/001

(57) ABSTRACT

Embodiments of a method and apparatus for wireless communications are disclosed. In an embodiment, a wireless device includes a controller configured to generate a coordinated beamforming (CBF) negotiation message and a wireless transceiver configured to conduct a CBF transmission preparing handshake using the CBF negotiation message during a CBF transmit opportunity (TXOP).

### CROSS-REFERENCE TO RELATED APPLICATIONS

This application is entitled to the benefit of Indian Provisional Application 202441082051, filed on Oct. 28, 2024, Indian Provisional Application 202441086609, filed on Nov. 11, 2024, U.S. Provisional Application 63/754,011, filed on Feb. 5, 2025, U.S. Provisional Application 63/757,271, filed on Feb. 11, 2025, U.S. Provisional Application 63/762,285, filed on Feb. 24, 2025, U.S. Provisional Application 63/775,896, filed on Mar. 21, 2025, U.S. Provisional Application 63/817,008, filed on Jun. 3, 2025, and U.S. Provisional Application 63/821,274, filed on Jun. 10, 2025, the contents of each of which are incorporated by reference herein in their entireties.

### BACKGROUND

Wireless communications devices, e.g., access points (APs) or non-AP devices transmit various types of information using different transmission techniques. For example, various applications, such as, Internet of Things (IoT) applications conduct wireless local area network (WLAN) communications, for example, based on Institute of Electrical and Electronics Engineers (IEEE) 802.11 family of standards (e.g., Wi-Fi standards). In multi-link communications, an access point (AP) multi-link device (MLD) wirelessly transmits data to one or more wireless stations in a non-AP MLD through one or more wireless communications links. Some applications, for example, video teleconferencing, streaming entertainment, high definition (HD) video surveillance applications, outdoor video sharing applications, etc., require relatively high system throughput.

### SUMMARY

Embodiments of a method and apparatus for wireless communications are disclosed. In an embodiment, a wireless device includes a controller configured to generate a coordinated beamforming (CBF) negotiation message and a wireless transceiver configured to conduct a CBF transmission preparing handshake using the CBF negotiation message during a CBF transmit opportunity (TXOP). Other embodiments are also disclosed.

In an embodiment, the wireless device includes a sharing wireless access point (AP) that shares the CBF TXOP, and the CBF negotiation message includes a CBF transmission invite.

In an embodiment, the CBF transmission invite includes a buffer status report poll (BSRP) non-trigger based (NTB) trigger frame, and the BSRP NTB trigger frame contains information indicating that the BSRP NTB trigger frame is used as the CBF transmission invite and information regarding whether the sharing wireless AP performs a polling of an associated wireless station (STA) of the sharing wireless AP.

In an embodiment, the wireless transceiver is further configured to wirelessly transmit the CBF transmission invite to a shared wireless AP with which the CBF TXOP is shared.

In an embodiment, the wireless transceiver is configured to wirelessly receive a CBF transmission response from the shared wireless AP.

In an embodiment, the CBF transmission response contains information regarding whether the shared wireless AP performs a polling of an associated wireless station (STA) of the shared wireless AP or information regarding whether the shared wireless AP accepts a CBF frame exchange with the sharing wireless AP.

In an embodiment, the CBF transmission response contains information indicating that the shared wireless AP rejects a CBF frame exchange with the sharing wireless AP and information indicating a rejection reason.

In an embodiment, the CBF transmission response includes a multi-STA block acknowledgement (Ack) that contains information indicating that the multi-STA block Ack is used as the CBF transmission response.

In an embodiment, the controller is further configured to generate an initial control frame (ICF) after the CBF transmission preparing handshake, and wherein the wireless transceiver is further configured to wirelessly transmit the ICF to a wireless station (STA) associated with the sharing wireless AP.

In an embodiment, the controller is further configured to generate a CBF Synchronization (Sync) message after the CBF transmission preparing handshake, and the wireless transceiver is further configured to wirelessly transmit the CBF Sync message.

In an embodiment, a dynamic channel puncture is not allowed in a CBF operation.

In an embodiment, the wireless device is compatible with an Institute of Electrical and Electronics Engineers (IEEE) 802.11 protocol.

In an embodiment, the wireless device includes a wireless multi-link device (MLD), and wherein the wireless transceiver is further configured to conduct a plurality of frame exchanges with a second wireless MLD through a plurality of wireless links between the wireless MLD and the second wireless MLD.

In an embodiment, a method for wireless communications includes at a wireless device, generating a coordinated beamforming (CBF) negotiation message and at the wireless device, conducting a CBF transmission preparing handshake using the CBF negotiation message during a CBF transmit opportunity (TXOP).

In an embodiment, the wireless device includes a sharing wireless access point (AP) that shares the CBF TXOP, and the CBF negotiation message includes a CBF transmission invite.

In an embodiment, the CBF transmission invite includes a buffer status report poll (BSRP) non-trigger based (NTB) trigger frame, and the BSRP NTB trigger frame contains information indicating that the BSRP NTB trigger frame is used as the CBF transmission invite and information regarding whether the sharing wireless AP performs a polling of an associated wireless station (STA) of the sharing wireless AP.

In an embodiment, at the wireless device, conducting the CBF transmission includes from the wireless device, wirelessly transmitting the CBF transmission invite to a shared wireless AP with which the CBF TXOP is shared.

In an embodiment, at the wireless device, conducting the CBF transmission further includes at the wireless device, wirelessly receiving a CBF transmission response from the shared wireless AP.

In an embodiment, the CBF transmission response contains information regarding whether the shared wireless AP performs a polling of an associated wireless station (STA) of the shared wireless AP or information regarding whether the shared wireless AP accepts a CBF frame exchange with the sharing wireless AP.

In an embodiment, the CBF transmission response contains information indicating that the shared wireless AP rejects a CBF frame exchange with the sharing wireless AP and information indicating a rejection reason.

Other aspects in accordance with the disclosure will become apparent from the following detailed description, taken in conjunction with the accompanying drawings, illustrated by way of example of the principles of the disclosure.

### BRIEF DESCRIPTION OF THE DRAWINGS

FIG. 1 depicts a wireless communications system in accordance with example embodiments.

FIG. 2 depicts a multi-link (ML) communications system that is used for wireless communications in accordance with example embodiments.

FIG. 3 depicts a wireless device in accordance with example embodiments.

FIG. 4 illustrates some communications between a sharing AP, a shared AP, and two stations (STAs) in a two-stage Coordinated beamforming (CBF) Transmit opportunity (TXOP) in accordance with example embodiments.

FIG. 5A illustrates a CBF negotiation request message in accordance with an embodiment of the disclosure.

FIG. 5B illustrates a CBF negotiation response message in accordance with an embodiment of the disclosure.

FIG. 6 illustrates some an initial control frame (ICF)/initial control response (ICR) time requirements set by the sharing AP and the shared AP in the two-stage CBF TXOP depicted in FIG. 4 in accordance with example embodiments.

FIG. 7 illustrates some multi-user (MU)-Block Acknowledgement Request (BAR)/Block Acknowledgement (BA) duration announcements by the sharing AP and the shared AP in the two-stage CBF TXOP depicted in FIG. 4 in accordance with example embodiments.

FIG. 8 is a process flow diagram of a method for wireless communications in accordance with example embodiments.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Thus, discussions of the features and advantages, and similar language, throughout this specification may, but do not necessarily, refer to the same embodiment.

Furthermore, the described features, advantages, and characteristics of the disclosure may be combined in any suitable manner in one or more embodiments. One skilled in the relevant art will recognize, in light of the description herein, that the disclosure can be practiced without one or more of the specific features or advantages of a particular embodiment. In other instances, additional features and advantages may be recognized in certain embodiments that may not be present in all embodiments of the disclosure.

Reference throughout this specification to “one embodiment”, “an embodiment”, or similar language means that a particular feature, structure, or characteristic described in connection with the indicated embodiment is included in at least one embodiment of the present disclosure. Thus, the phrases “in one embodiment”, “in an embodiment”, and similar language throughout this specification may, but do not necessarily, all refer to the same embodiment.

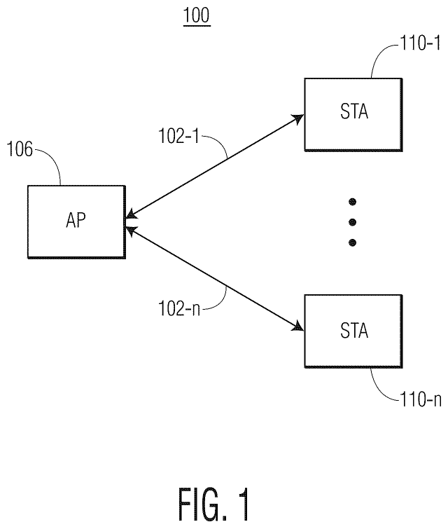

FIG. 1 depicts a wireless (e.g., WiFi) communications system 100 in accordance with an embodiment of the disclosure. In the embodiment depicted in FIG. 1, the wireless communications system 100 includes at least one AP 106 and at least one station (STA) 110-1, . . . , 110-n, where n is a positive integer. The wireless communications system can be used in various applications, such as industrial applications, medical applications, computer applications, and/or consumer or enterprise applications. In some embodiments, the wireless communications system is compatible with an IEEE 802.11 protocol. Although the depicted wireless communications system 100 is shown in FIG. 1 with certain components and described with certain functionality herein, other embodiments of the wireless communications system may include fewer or more components to implement the same, less, or more functionality. For example, in some embodiments, the wireless communications system includes multiple APs with multiple STAs, one AP with one STA, or one AP with multiple STAs. In another example, although the wireless communications system is shown in FIG. 1 as being connected in a certain topology, the network topology of the wireless communications system is not limited to the topology shown in FIG. 1. In some embodiments, the wireless communications system 100 described with reference to FIG. 1 involves single-link communications and the AP and the STA communicate through single communications link. In some embodiments, the AP 106 may be affiliated with an AP MLD, and a STA 100-j with j being an integer equal to one of 1 to n may be affiliated with a STA MLD j (=non-AP MLD j).

In the embodiment depicted in FIG. 1, the AP 106 may be implemented in hardware (e.g., circuits), software, firmware, or a combination thereof. The AP 106 may be fully or partially implemented as an integrated circuit (IC) device. In some embodiments, the AP 106 is a wireless AP compatible with at least one WLAN communications protocol (e.g., at least one IEEE 802.11 protocol). In some embodiments, the AP is a wireless AP that connects to a local area network (LAN) and/or to a backbone network (e.g., the Internet) through a wired connection and that wirelessly connects to one or more wireless stations (STAs), for example, through one or more WLAN communications protocols, such as the IEEE 802.11 protocol. In some embodiments, the AP includes at least one antenna, at least one transceiver operably connected to the at least one antenna, and at least one controller operably connected to the corresponding transceiver. In some embodiments, the transceiver includes a physical layer (PHY) device. The controller may be configured to control the transceiver to process received packets through the antenna. In some embodiments, the controller is implemented within a processor, such as a microcontroller, a host processor, a host, a digital signal processor (DSP), or a central processing unit (CPU), which can be integrated in a corresponding transceiver. In some embodiments, the AP 106 (e.g., a controller or a transceiver of the AP) implements upper layer Media Access Control (MAC) functionalities (e.g., beacon, association establishment, reordering of frames, etc.) and/or lower layer MAC functionalities (e.g., backoff, frame transmission, frame reception, etc.). Although the wireless communications system 100 is shown in FIG. 1 as including one AP, other embodiments of the wireless communications system 100 may include multiple APs. In these embodiments, each of the APs of the wireless communications system 100 may operate in a different frequency band. For example, one AP may operate in a 2.4 gigahertz (GHz) frequency band and another AP may operate in a 5 GHz frequency band.

In the embodiment depicted in FIG. 1, each of the at least one STA 110-1, . . . , 110-n may be implemented in hardware (e.g., circuits), software, firmware, or a combination thereof. The STA 110-1, . . . , or 110-n may be fully or partially implemented as IC devices. In some embodiments, the STA 110-1, . . . , or 110-n is a communication device compatible with at least one IEEE 802.11 protocol. In some embodiments, the STA 110-1, . . . , or 110-n is implemented in a laptop, a desktop personal computer (PC), a mobile phone, or other communications device that supports at least one WLAN communications protocol. In some embodiments, the STA 110-1, . . . , or 110-n implements upper layer MAC functionalities and lower layer MAC layer functionalities. In some embodiments, the STA 110-1, . . . , or 110-n includes at least one antenna, at least one transceiver operably connected to the at least one antenna, and at least one controller connected to the corresponding transceiver. In some embodiments, the transceiver includes a PHY device. The controller may be configured to control the transceiver to process received packets through the antenna. In some embodiments, the controller is implemented within a processor, such as a microcontroller, a host processor, a host, a DSP, or a CPU, which can be integrated in a corresponding transceiver.

In the embodiment depicted in FIG. 1, the AP 106 communicates with the at least one STA 110-1, . . . , 110-n via a communication link 102-1, . . . , 102-n, where n is a positive integer. In some embodiments, data communicated between the AP and the at least one STA 110-1, . . . , 110-n includes MAC protocol data units (MPDUs). An MPDU may include a frame header, a frame body, and a trailer with the MPDU payload encapsulated in the frame body.

In some embodiments of a wireless communications system, a wireless device, e.g., an access point (AP) multi-link device (MLD) of a wireless local area network (WLAN) may transmit data to at least one associated station (STA) MLD. The AP MLD may be configured to operate with associated STA MLDs according to a communication protocol. For example, the communication protocol may be an Ultra High Reliability (UHR) communication protocol, or an Institute of Electrical and Electronics Engineer (IEEE) 802.11 communication protocol (e.g., an IEEE 802.11bn communication protocol). In some embodiments of the wireless communications system described herein, different associated STAs within range of an AP operating according to the UHR communication protocol are configured to operate according to at least one other communication protocol, which defines operation in a Basic Service Set (BSS) with the AP, but are generally affiliated with lower reliable protocols. The lower reliable communication protocols (e.g., Extremely High Throughput (EHT) communication protocol that is compatible with IEEE 802.11be standards, High Efficiency (HE) communication protocol that is compatible with IEEE 802.11ax standards, Very High Throughput (VHT) communication protocol that is compatible with IEEE 802.11ac standards, etc.) may be collectively referred to herein as “legacy” communication protocols.

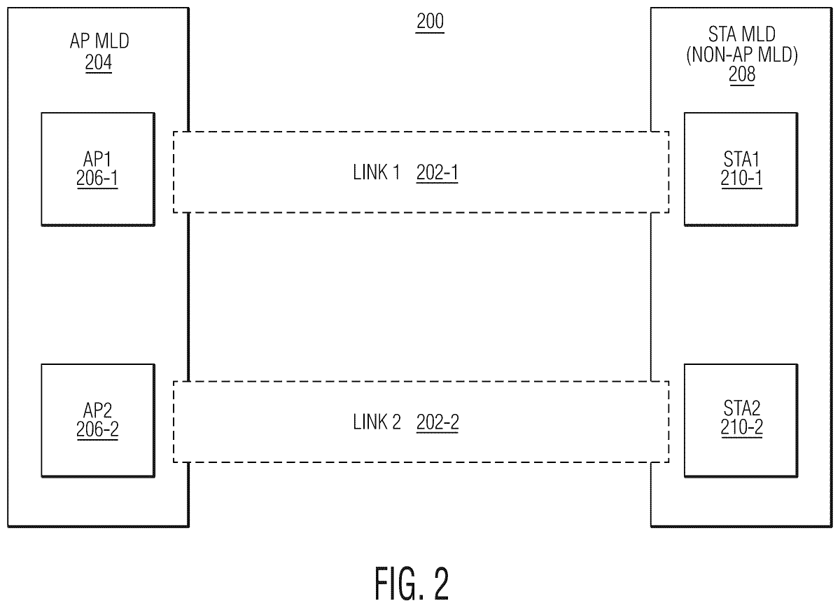

FIG. 2 depicts a multi-link (ML) communications system 200 that is used for wireless (e.g., WiFi) communications in accordance with an embodiment of the disclosure. In the embodiment depicted in FIG. 2, the multi-link communications system includes one AP multi-link device, which is implemented as AP MLD 204, and one non-AP STA multi-link device, which is implemented as STA MLD (non-AP MLD) 208. The multi-link communications system can be used in various applications, such as industrial applications, medical applications, computer applications, and/or consumer or enterprise applications.

In some embodiments, the multi-link communications system may be a wireless communications system, such as a wireless communications system compatible with an IEEE 802.11 protocol. For example, the multi-link communications system may be a wireless communications system compatible with an IEEE 802.11bn protocol. Although the depicted multi-link communications system 200 is shown in FIG. 2 with certain components and described with certain functionality herein, other embodiments of the multi-link communications system may include fewer or more components to implement the same, less, or more functionality. For example, in some embodiments, the multi-link communications system includes a single AP MLD with multiple STA MLDs, or multiple AP MLDs with more than one STA MLD. In some embodiments, the legacy STAs (non-UHR STAs) may associate with one of the APs affiliated with the AP MLD. In another example, although the multi-link communications system is shown in FIG. 2 as being connected in a certain topology, the network topology of the multi-link communications system is not limited to the topology shown in FIG. 2.

In the embodiment depicted in FIG. 2, the AP MLD 204 includes two APs in two links, implemented as APs 206-1 and 206-2. In such an embodiment, the APs may be AP1 206-1 and AP2206-2. In some embodiments, a common part of the AP MLD 204 implements upper layer Media Access Control (MAC) functionalities that are common to multiple links (e.g., association establishment, reordering of frames, etc.) and a link specific part of the AP MLD 204, i.e., the APs 206-1 and 206-2, implement upper layer functionalities specific to a link and the lower layer MAC functionalities (e.g., Beaconing, backoff, frame transmission, frame reception, etc.). The APs 206-1 and 206-2 may be implemented in hardware (e.g., circuits), software, firmware, or a combination thereof. The APs 206-1 and 206-2 may be fully or partially implemented as an integrated circuit (IC) device. In some embodiments, the APs 206-1 and 206-2 may be wireless APs compatible with at least one WLAN communications protocol (e.g., at least one IEEE 802.11 protocol). For example, the APs 206-1 and 206-2 may be wireless APs compatible with an IEEE 802.11bn protocol. In some embodiments, an AP MLD (e.g., AP MLD 204) connects to a local network (e.g., a LAN) and/or to a backbone network (e.g., the Internet) through a wired connection and wirelessly connects to wireless STAs, for example, through one or more WLAN communications protocols, such as an IEEE 802.11 protocol. In some embodiments, an AP (e.g., AP1 206-1 and/or AP2 106-2) includes at least one antenna, at least one transceiver operably connected to the at least one antenna, and at least one controller operably connected to the corresponding transceiver. In some embodiments, at least one transceiver includes a physical layer (PHY) device. The at least one controller may be configured to control the at least one transceiver to process received packets through the at least one antenna. In some embodiments, the at least one controller may be implemented within a processor, such as a microcontroller, a host processor, a host, a digital signal processor (DSP), or a central processing unit (CPU), which can be integrated in a corresponding transceiver. In some embodiments, each of the APs 206-1 or 206-2 of the AP MLD 204 may operate in a different BSS operating channel. For example, AP1 206-1 may operate in a 320 MHz (one million hertz) BSS operating channel at 6 Gigahertz (GHz) band and AP2 206-2 may operate in a 160 MHz BSS operating channel at 5 GHz band. Although the AP MLD 204 is shown in FIG. 2 as including two APs, other embodiments of the AP MLD 204 may include more than two APs or only one AP.

In the embodiment depicted in FIG. 2, the non-AP STA multi-link device, implemented as STA MLD 208, includes STAs non-AP STAs 210-1 and 210-2 on two links. In such an embodiment, the non-AP STAs may be STA1 210-1 and STA2 210-2. The STAs 210-1 and 210-2 may be implemented in hardware (e.g., circuits), software, firmware, or a combination thereof. The STAs 210-1 and 210-2 may be fully or partially implemented as an IC device. In some embodiments, the non-AP STAs 210-1 and 210-2 are part of the STA MLD 208, such that the STA MLD may be a communications device that wirelessly connects to a wireless AP MLD. For example, the STA MLD 208 may be implemented in a laptop, a desktop personal computer (PC), a mobile phone, or other communications device that supports at least one WLAN communications protocol. In some embodiments, the non-AP STA MLD 208 is a communications device compatible with at least one IEEE 802.11 protocol (e.g., an IEEE 802.11 bn protocol, an IEEE 802.11be protocol, an IEEE 802.11ax protocol, or an IEEE 802.11ac protocol). In some embodiments, the STA MLD 208 implements a common MAC data service interface and the non-AP STAs 210-1 and 210-2 implement a lower layer MAC data service interface.

In some embodiments, the AP MLD 204 and/or the STA MLD 208 may identify which communication links support multi-link operation during a multi-link operation setup phase and/or exchanges information regarding multi-link capabilities during the multi-link operation setup phase. In some embodiments, each of the non-AP STAs 210-1 and 210-2 of the STA MLD 208 may operate in a different frequency band. For example, the non-AP STA 210-1 may operate in the 2.4 GHz frequency band and the non-AP STA 210-2 may operate in the 5 GHz frequency band. In some embodiments, each STA includes at least one antenna, at least one transceiver operably connected to the at least one antenna, and at least one controller connected to the corresponding transceiver. In some embodiments, at least one transceiver includes a PHY device. The at least one controller may be configured to control the at least one transceiver to process received packets through the at least one antenna. In some embodiments, the at least one controller may be implemented within a processor, such as a microcontroller, a host processor, a host, a DSP, or a CPU, which can be integrated in a corresponding transceiver.

In the embodiment depicted in FIG. 2, the STA MLD 208 communicates with the AP MLD 204 via two communication links, e.g., link 1 202-1 and link 2 202-2. For example, each of the non-AP STAs 210-1 or 210-2 communicates with an AP 206-1 or 206-2 via corresponding communication links 202-1 or 202-2. In an embodiment, a communication link (e.g., link 1 202-1 or link 2 202-2) may include a BSS operating channel established by an AP (e.g., AP1 206-1 or AP2 206-2) that features multiple 20 MHz channels used to transmit frames (e.g., beacon frames, management frames, etc., in Physical Layer Protocol Data Units (PPDUs)) between a first wireless device (e.g., an AP, an AP MLD, an STA, or an STA MLD) and a second wireless device (e.g., an AP, an AP MLD, an STA, or an STA MLD). In some embodiments, a 20 MHz channel covered by the BSS operating channel may be a punctured 20 MHz channel or an unpunctured 20 MHz channel. Although the STA MLD 208 is shown in FIG. 2 as including two non-AP STAs, other embodiments of the STA MLD 208 may include one non-AP STA or more than two non-AP STAs. In addition, although the AP MLD 204 communicates (e.g., wirelessly communicates) with the STA MLD 208 via the communications links 202-1 and 202-2, in other embodiments, the AP MLD 204 may communicate (e.g., wirelessly communicate) with the STA MLD 208 via more than two communication links or less than two communication links.

In some embodiments, a first MLD, e.g., an AP MLD or non-AP MLD (STA MLD), may transmit MLD-level management frames in a multi-link operation with a second MLD, e.g., STA MLD or AP MLD, to coordinate the multi-link operation between the first MLD and the second MLD. As an example, a management frame may be a channel switch announcement frame, a (Re)Association Request frame, a (Re)Association Response frame, a Disassociation frame, an Authentication frame, and/or a Block Acknowledgement (Ack) (BA) Action frame, etc. In some embodiments, an AP/STA of a first MLD may transmit link-level management frames to a STA/AP of a second MLD. In some embodiments, one or more link-level management frames may be transmitted via a cross-link transmission (e.g., according to an IEEE 802.11bn communication protocol). As an example, a cross-link management frame transmission may involve a management frame being transmitted and/or received on one link (e.g., the link 1 202-1) while carrying information of another link (e.g., the link 2 202-2). In some embodiments, a management frame is transmitted on any link (e.g., at least one of two links or at least one of multiple links) between a first MLD (e.g., the AP MLD 204) and a second MLD (e.g., the STA MLD 208). As an example, a management frame may be transmitted between a first MLD and a second MLD on any link (e.g., at least one of two links or at least one of multiple links) associated with the first MLD and the second MLD.

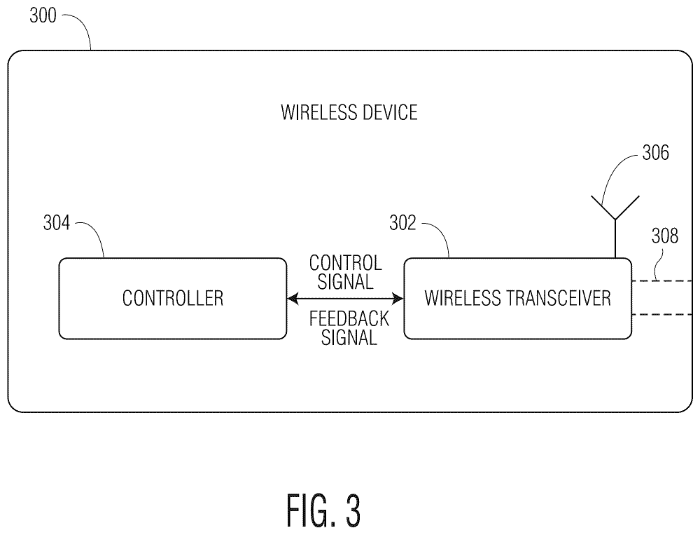

FIG. 3 depicts a wireless device 300 in accordance with an embodiment of the disclosure. The wireless device 300 can be used in the wireless communications system 100 depicted in FIG. 1 and/or the multi-link communications system 200 depicted in FIG. 2 for each link independently. For example, the wireless device 300 may be an embodiment of the AP 106 depicted in FIG. 1, the STA 110-1, . . . , 110-n depicted in FIG. 1, the APs 206-1, 206-2 depicted in FIG. 2, and/or the STAs 210-1, 210-2 depicted in FIG. 2. In the embodiment depicted in FIG. 3, the wireless device 300 includes a wireless transceiver 302, a controller 304 operably connected to the wireless transceiver, and at least one antenna 306 operably connected to the wireless transceiver. In some embodiments, the wireless device 300 may include at least one optional network port 308 operably connected to the wireless transceiver. In some embodiments, the wireless transceiver includes a physical layer (PHY) device.

The wireless transceiver may be any suitable type of wireless transceiver. For example, the wireless transceiver may be a LAN transceiver (e.g., a transceiver compatible with an IEEE 802.11 protocol). In some embodiments, the wireless device 300 includes multiple transceivers. The controller may be configured to control the wireless transceiver (e.g., by generating a control signal) to process packets received through the antenna and/or the network port and/or to generate outgoing packets to be transmitted through the antenna and/or the network port. In some embodiments, the wireless transceiver transmits one or more feedback signals to the controller. In some embodiments, the controller is implemented within a processor, such as a microcontroller, a host processor, a host, a DSP, or a CPU. In some embodiments, the wireless transceiver 302 is implemented in hardware (e.g., circuits), software, firmware, or a combination thereof. The antenna may be any suitable type of antenna. For example, the antenna may be an induction type antenna such as a loop antenna or any other suitable type of induction type antenna. However, the antenna is not limited to an induction type antenna. The network port may be any suitable type of port.

To facilitate the proper data transmission within a wireless communications system, there is a need for wireless communications technology that can efficiently and securely convey wireless communications information, for example, information related to data, communications links, and/or wireless devices (e.g., operation and/or capability parameters of wireless devices) within the wireless communications system.

In accordance with an embodiment of the disclosure, the controller 304 is configured to generate a coordinated beamforming (CBF) negotiation message, and the wireless transceiver 302 is configured to conduct a CBF transmission preparing handshake (for example, taking part in the operation or management of the CBF transmission preparing handshake, such as to negotiate control information between a sharing AP and a shared AP for simultaneously transmitting the downlink (DL) QoS Data frames in two DL PPDUs from the two APs) using the CBF negotiation message carried in control frames during a CBF transmit opportunity (TXOP), for example, through the at least one antenna 306.

Coordinated beamforming (CBF) is a wireless communication technique in which multiple wireless access points (APs) coordinate their beamforming efforts to reduce interference and improve performance, particularly for users at coverage edges. For example, using CBF, multiple APs can simultaneously communicate with multiple stations (STAs) wirelessly on the same frequency band. CBF may involve multiple APs beamforming together by creating constructive interference (peaks) for target STAs or users and destructive interference (nulls) in the direction of other STAs or users to minimize interference, resulting in better coverage, higher data rates, and improved system throughput. For example, an AP may act as a sharing AP that shares a transmission opportunity (TXOP) with a coordinated AP or a shared AP to perform CBF transmissions.

In some embodiments, the wireless device 300 includes a sharing wireless access point (AP) that shares the CBF TXOP (e.g., shares a wireless channel during the CBF TXOP), and the CBF negotiation message includes a CBF transmission invite.

In some embodiments, the CBF transmission invite is carried in a buffer status report poll (BSRP) non-trigger based (NTB) trigger frame, and the BSRP NTB trigger frame contains information explicitly indicating that the BSRP NTB trigger frame is used as the CBF transmission invite and information regarding whether the sharing wireless AP performs a polling of an associated wireless station (STA) of the sharing wireless AP.

In some embodiments, the wireless transceiver 302 is further configured to wirelessly transmit the CBF transmission invite to a shared wireless AP with which the CBF TXOP (e.g., a wireless channel during the CBF TXOP) is shared, for example, through the at least one antenna 306.

In some embodiments, the wireless transceiver 302 is further configured to wirelessly receive a CBF transmission response from the shared wireless AP, for example, through the at least one antenna 306.

In some embodiments, the CBF transmission response contains information explicitly indicating whether the shared wireless AP performs a polling of an associated wireless station (STA) of the shared wireless AP or information regarding whether the shared wireless AP accepts a CBF frame exchange with the sharing wireless AP.

In some embodiments, the CBF transmission response contains information indicating that the shared wireless AP rejects a CBF frame exchange with the sharing wireless AP and information indicating a rejection reason.

In some embodiments, the CBF transmission response is carried in a multi-STA block acknowledgement (Ack) that contains information explicitly indicating that the multi-STA block Ack is used as the CBF transmission response.

In some embodiments, the controller 304 is further configured to generate an initial control frame (ICF) after the CBF transmission preparing handshake, and the wireless transceiver 302 is further configured to wirelessly transmit the ICF to a wireless station (STA) associated with the sharing wireless AP. In some embodiments, the STA is a DPS STA or a STA in an EMLSR link.

In some embodiments, the controller 304 is further configured to generate a CBF Synchronization (Sync) message after the CBF transmission preparing handshake, and the wireless transceiver 302 is further configured to wirelessly transmit the CBF Sync message, for example, through the at least one antenna 306.

In some embodiments, a dynamic channel puncture is not allowed in a CBF operation.

In some embodiments, the wireless device 300 is compatible with an Institute of Electrical and Electronics Engineers (IEEE) 802.11 protocol.

In some embodiments, the wireless device 300 includes a wireless multi-link device (MLD), and the wireless transceiver 302 is further configured to conduct frame exchanges (for example, taking part in the operation or management of frame exchanges, such as to transmit and receive frames) with a second wireless MLD through wireless links between the wireless MLD and the second wireless MLD.

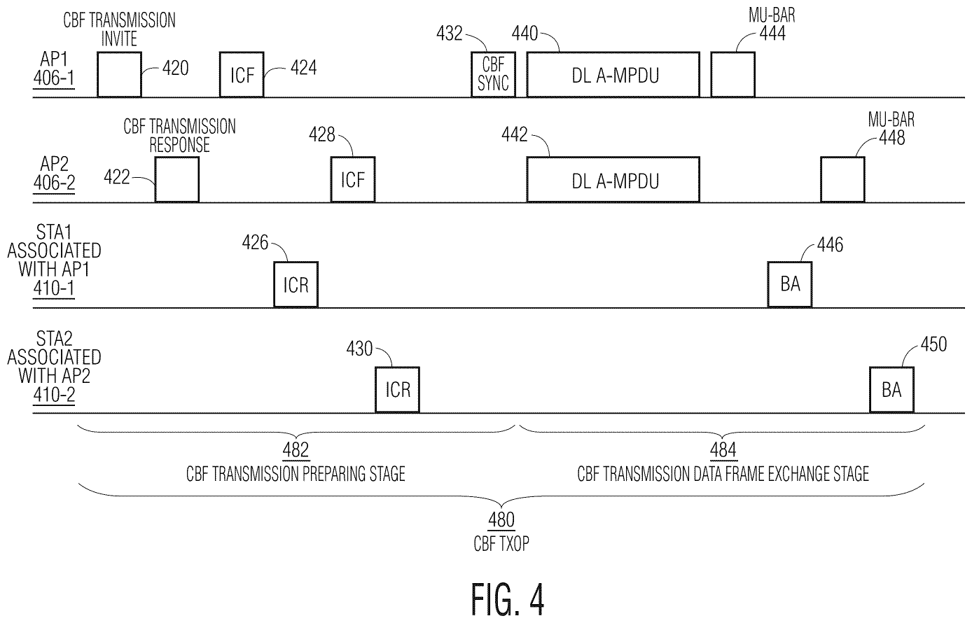

FIG. 4 illustrates some communications between a sharing AP 406-1, a shared AP 406-2, and two stations (STAs) 410-1, 410-2 in a two-stage Coordinated beamforming (CBF) Transmit opportunity (TXOP) 480 in accordance with example embodiments. In some embodiments, the sharing AP 406-1, which is also referred to as AP1, shares the CBF TXOP 480 with the shared AP 406-2 and the shared AP 406-2, which is also referred to as AP2, is an AP with which the CBF TXOP 480 is shared. In some embodiments, the STA 410-1, which is also referred to as STA1, associates with the sharing AP 406-1 and the STA 410-2, which is also referred to as STA2, associates with the shared AP 406-2. As illustrated in FIG. 4, the two-stage CBF TXOP 480 includes a CBF transmission preparing stage 482 (also referred to as a polling stage) and a CBF transmission data frame exchange stage (also referred to as a CBF PPDUs transmission (Tx)/Reception (Rx) stage) 484. In some embodiments, the CBF transmission preparing stage/polling stage 482 does not assume that the shared AP 406-1 supports trigger based (TB) PPDU transmission. The sharing AP 406-1 and/or the shared AP 406-2 depicted in FIG. 4 may be the same as or similar to an embodiment of the AP 106 depicted in FIG. 1, the APs 206-1, 206-2 depicted in FIG. 2, and/or the wireless device 300 depicted in FIG. 3. The STA 410-1 and/or the STA 410-2 depicted in FIG. 4 may be the same as or similar to an embodiment of the STA 110-1, . . . , or 110-n depicted in FIG. 1, the STA 210-1 or 210-32 depicted in FIG. 2, and/or the wireless device 300 depicted in FIG. 3.

As illustrated in FIG. 4, in a time sequence during the CBF transmission preparing stage 482, the sharing AP (AP1) 406-1 transmits a CBF transmission invite/invitation 420 to the shared AP (AP2) 406-2 and the shared AP (AP2) 406-2 transmits a CBF transmission response 422 to the sharing AP (AP1) 406-1. Subsequently, the sharing AP (AP1) 406-1 transmits an Initial Control Frame (ICF) 424 to the STA (STA1) 410-1 and the STA (STA1) 410-1 transmits an initial control response (ICR) 426 (e.g., embedded or carried in a TB PPDU) to the sharing AP (AP1) 406-1 if/when the ICF/ICR exchange helps the readiness of STA1's data frame reception. The shared AP (AP2) 406-2 transmits an ICF 428 to the STA (STA2) 410-2 and the STA (STA2) 410-2 transmits an ICR 430 (e.g., embedded or carried in a TB PPDU) to the shared AP (AP2) 406-2 if/when the ICF/ICR exchange helps the readiness of STA2's data frame reception. Subsequently, the sharing AP (AP1) 406-1 transmits a CBF synchronization (SYNC) message 432 to synchronize the DL MU PPDU transmission from both the sharing AP (AP1) 406-1 and the shared AP (AP2) 406-2.

Subsequently, as illustrated in FIG. 4, in a time sequence during the CBF transmission data frame exchange stage 484, the sharing AP (AP1) 406-1 transmits a downlink (DL) Aggregated MAC Protocol Data Unit (A-MPDU) 440 and the shared AP (AP2) 406-2 transmits a DL A-MPDU 442. Subsequently, the sharing AP (AP1) 406-1 transmits a Multi-user (MU)-block acknowledgement request (BAR) 444 to the STA (STA1) 410-1 and the STA (STA1) 410-1 transmits a block acknowledgement (BA) 446 to the sharing AP (AP1) 406-1. Subsequently, the shared AP (AP2) 406-2 transmits a MU-BAR 448 to the STA (STA2) 410-2 and the STA (STA2) 410-2 transmits a block acknowledgement (BA) 450 to the shared AP (AP2) 406-2.

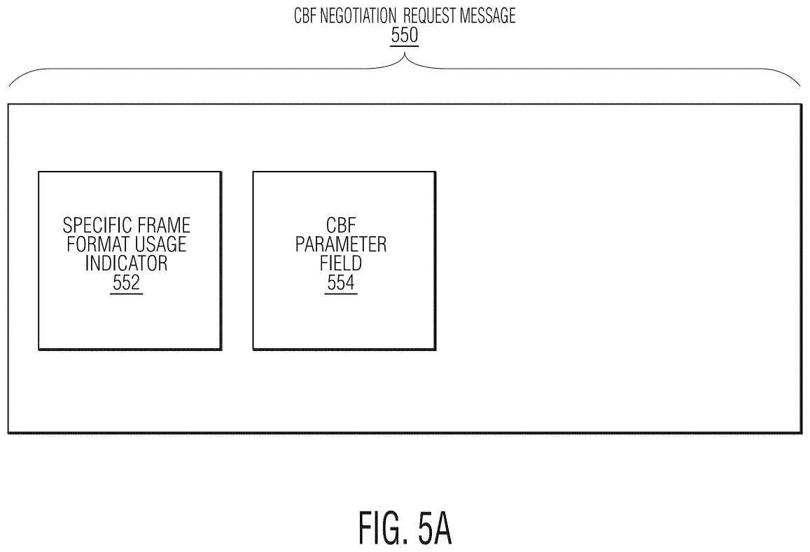

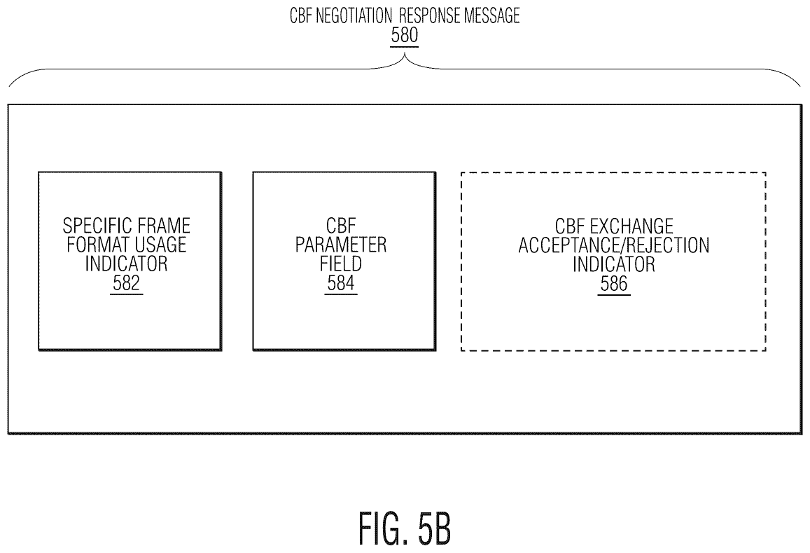

FIG. 5A illustrates a CBF negotiation request message 550 in accordance with an embodiment of the disclosure. The CBF negotiation request message 550 illustrated in FIG. 5A can be used for communications by the wireless communications system 100 depicted in FIG. 1, by an AP affiliated with the multi-link (ML) communications system 200 depicted in FIG. 2 acting as a sharing AP, the wireless device 300 depicted in FIG. 3, and the sharing AP (AP1) 406-1 depicted in FIG. 4. In the embodiment depicted in FIG. 5A, the CBF negotiation request message 550 (e.g., a CBF negotiation invite message) includes a specific frame format usage indicator 552 and a CBF parameter field 554. In some embodiments, the specific frame format usage indicator 552 contains information indicating that a specific frame format is used for the CBF negotiation request message. In some embodiments, the CBF parameter field 554 contains information indicating the capability of a wireless device that generates the CBF negotiation request message. In some embodiments, the wireless device that generates the CBF negotiation request message (e.g., a sharing AP) fixes, determines, or decides all the participating STAs including a shared AP's STAs (e.g., the shared AP (AP2) 406-2's the STA (STA2) 410-2 depicted in FIG. 4) and the Number of Spatial Streams (Nss) combination. In some embodiments, the wireless device that generates the CBF negotiation request message (e.g., a sharing AP) fixes, determines, or decides the total number of users, and the total number of streams which will participate in the CBF transmission. In some embodiments, the wireless device that generates the CBF negotiation request message (e.g., a sharing AP) also notifies the STAs, which will be scheduled from the wireless device along with the corresponding STA-ID and Nss used for each of those STAs. In some embodiments, the CBF parameter field 554 is one or multiple Feedback User Info fields.

In some embodiments, the CBF negotiation request message 550 includes a CBF transmission invite, which is carried in a buffer status report poll (BSRP) non-trigger based (NTB) trigger frame, the specific frame format usage indicator 552 contains information indicating that the BSRP NTB trigger frame is used as the CBF transmission invite. In some embodiments, the specific frame format usage indicator 552 is carried in the Common Info field or Special User Info field by repurposing the reserved bit in Common Info field for such indication. In some embodiments, the specific frame format usage indicator 552 is carried in the Type field of the Feedback User Info field. In some embodiments, the CBF parameter field 554 contains the parameters of a wireless AP that generates the CBF transmission invite. In some embodiments, the CBF parameter field 554 is one or multiple Feedback User Info fields.

FIG. 5B illustrates a CBF negotiation response message 580 in accordance with an embodiment of the disclosure. The CBF negotiation response message 580 illustrated in FIG. 5B can be used for communications by the wireless communications system 100 depicted in FIG. 1, by an AP affiliated with the multi-link (ML) communications system 200 depicted in FIG. 2 acting as a shared AP, the wireless device 300 depicted in FIG. 3, and the shared AP (AP2) 406-2, depicted in FIG. 4. In the embodiment depicted in FIG. 5B, the CBF negotiation response message 580 includes a specific frame format usage indicator 582, a CBF parameter field 584, and a CBF exchange acceptance/rejection indicator 586. In some embodiments, the specific frame format usage indicator 582 contains information indicating that a specific frame format is used by the CBF negotiation response message. In some embodiments, the CBF parameter field 554 contains the CBF parameter of a wireless device that generates the CBF negotiation response message. In some embodiments, if/when a wireless device that generates the CBF negotiation response message (e.g., a shared AP) agrees to a CBF negotiation initiator (e.g., a sharing AP)'s selection, the wireless device will indicate that it will participate in the coordinated related transactions using a Multi-STA Block Ack frame as a CBF transmission response. In some embodiments, if/when a wireless device that generates the CBF negotiation response message (e.g., a shared AP) does not agree with a CBF negotiation initiator (e.g., a sharing AP)'s selection, the wireless device will indicate that it will not be participating in the coordinated related transactions using a Multi-STA Block Ack frame. In some embodiments, a wireless device that generates the CBF negotiation response message (e.g., a shared AP) shares the STA-ID of the participating STAs and Nss of the corresponding STAs in a Multi-STA Block Ack as a CBF transmission response.

In some embodiments, the CBF negotiation response message 580 includes a CBF transmission response, which is carried in a Multi-STA Block Ack frame, the specific frame format usage indicator 582 contains information indicating that the Multi-STA Block Ack frame is used as the CBF transmission response. In some embodiments, the specific frame format usage indicator 582 is carried in the Block Ack Control field by repurposing the reserved bit in Block Ack Control field for such indication. In some embodiments, the specific frame format usage indicator 582 is carried in the Type field of the Feedback Per Association Identifier (AID) Traffic Identifier (TID) Information (Info) field. In some embodiments, the CBF parameter field 584 contains the parameter information selected by a shared wireless AP. In some embodiments, the CBF parameter field 584 is one or multiple Feedback Per AID TID Info fields. In some embodiments, the CBF exchange acceptance/rejection indicator 586 is carried in a Feedback Per AID TID Info field.

In some implementations, before CBF frame exchanges, the sharing AP polls its associated STA for CBF frame exchanges, then the shared AP polls its associated STA for CBF frame exchanges.

In some embodiments, a sharing AP controls the usage of a CBF TXOP, whether or not the CBF TXOP is protected until the end of the CBF TXOP, and/or whether a shared AP needs to poll its associated STA's available bandwidth (BW).

In some embodiments, the first BSRP NTB Trigger carrying a CBF negotiation invite message carries the CBF transmission parameters, such as, its STA(s) for CBF operation in the CBF TXOP, and the shared AP selects and announce its STA(s) for CBF operation per sharing AP's STA(s).

In some embodiments, the first ICF announces the CBF group that conducts Tx/Rx of CBF PPDUs, whether the shared AP polls its associated STA's available BW.

In some embodiments, channel puncture under CBF operation is disallowed.

In some embodiments, CBF agreement establishment is implemented.

Some implementations of CBF Transmission Preparing Stage-Handshake, for example, by the wireless communications system 100 depicted in FIG. 1, the AP/STA of the multi-link (ML) communications system 200 in a link depicted in FIG. 2, the wireless device 300 depicted in FIG. 3, and/or the sharing AP (AP1) 406-1, the shared AP (AP2) 406-2, the STA (STA1) 410-1, and/or the STA (STA2) 410-2 depicted in FIG. 4 are described.

In some embodiments, in CBF transmission preparing handshake (CBF transmission invite/response) option 1, a sharing AP (e.g., the sharing AP (AP1) 406-1 depicted in FIG. 4) fixes, determines, or decides all the participating STAs including a shared AP's STAs (e.g., the shared AP (AP2) 406-2's the STA (STA2) 410-2 depicted in FIG. 4) and the Number of Spatial Streams (Nss) combination using a BSRP NTB Trigger frame as a CBF transmission invite. In some embodiments, if/when the shared AP (e.g., the shared AP (AP2) 406-2 depicted in FIG. 4) agrees to the sharing AP's selection, the shared AP will indicate that it will participate in the coordinated related transactions using a Multi-STA Block Ack frame as a CBF transmission response. In some embodiments, if/when the shared AP does not agree with the sharing AP's selection, the shared AP will indicate that it will not be participating in the coordinated related transactions using a Multi-STA Block Ack frame.

In some embodiments, in CBF transmission preparing handshake (CBF transmission invite/response) option 2, a sharing AP (e.g., the sharing AP (AP1) 406-1 depicted in FIG. 4) fixes, determines, or decides the total number of users, and the total number of streams which will participate in the CBF transmission in a BSRP NTB Trigger frame as a CBF transmission invite. In some embodiments, the sharing AP also notifies the STAs (e.g., the STA (STA2) 410-2 depicted in FIG. 4), which will be scheduled from the sharing AP along with the corresponding STA-ID and Nss used for each of those STAs. In some embodiments, a shared AP (e.g., the shared AP (AP2) 406-2 depicted in FIG. 4) shares the STA-ID of the participating STAs and Nss of the corresponding STAs in a Multi-STA Block Ack as a CBF transmission response. In some embodiments, if the sharing AP agrees to all the parameters, the sharing AP will go forward with the coordinated related transactions, otherwise the sharing AP will not go forward with the coordinated related transactions. In some embodiments, in another variant, the sharing AP always agree with the shared AP's decision.

In some embodiments, a CBF Transmission Invite/Invitation (e.g. a Buffer Status Report Poll (BSRP) non-trigger based (NTB) Trigger frame) in a TXOP that negotiates the CBF transmission in the TXOP carries the following information besides the information described in Option 1 or Option 2:
whether the sharing AP performs the polling of its associated STA.

In some embodiments, a CBF Transmission response (e.g., a Multi-STA BA frame) in a TXOP that negotiates the CBF transmission in the TXOP carries the following information besides the information described in Option 1 or Option 2:
whether the shared AP performs the polling of its associated STA.

In some embodiments, a CBF Transmission Response (e.g., a Multi-STA BA) in a TXOP that negotiates the CBF transmission in the TXOP carries the following information besides the information described in Option 1 or Option 2:
whether the shared AP performs the polling of its associated STA;
whether to accept the CBF frame exchange.

In some embodiments, if/when rejecting the CBF frame exchange, the shared AP provides the rejection reason. For example, the sounding result of the other BSS does not exist, or the shared AP or/and its associated STA(s) is/are not available.

Some implementations of CBF Transmission Prepare Stage-CBF Transmission Invite/Response, for example, by the wireless communications system 100 depicted in FIG. 1, the AP/STA of the multi-link (ML) communications system 200 in a link depicted in FIG. 2, the wireless device 300 depicted in FIG. 3, and/or the sharing AP (AP1) 406-1, the shared AP (AP2) 406-2, the STA (STA1) 410-1, and/or the STA (STA2) 410-2 depicted in FIG. 4 are described.

In some embodiments, a BSRP NTB Trigger frame is used as a CBF Transmission Invite/Invitation. In some embodiments, the reserved bit in a Common Info field or an IEEE 802.11be's Special User Info field being repurposed to indicate that the BSRP NTB Trigger frame is used as the CBF Transmission Invite. In some embodiments, in another variant, a special User Info field(s) whose AID12 field with a value more than 2007 indicates that the BSRP NTB is used as the CBF Transmission Invite. In some embodiments, in a third option, a new value in a Type field of a Feedback User Info field indicates that the BSRP NTB is used as the CBF Transmission Invite. Such special User Info field(s) carries the parameters for CBF transmission invite negotiation.

In some embodiments, a Multi-STA Block Ack (BA) is used as a CBF Transmission Response. In some embodiments, one reserved bit in a BA Control field being repurposed to indicate that the Multi-STA Block Ack is used as the CBF Transmission Response. In some embodiments, in another variant, Per Association ID (AID) Traffic Identifier (TID) Info whose AID12 field with a value more than 2007 indicates that the Multi-STA Block Ack is used as the CBF Transmission Response. In some embodiments, in a third option, a new value in a Type field of a Feedback User Info field indicates the Multi-STA Block Ack is used as the CBF Transmission Response. Such Per AID TID Info field(s) carries the parameters for CBF transmission invite negotiation.

Some implementations of ICF/ICR, MU-BAR/BA Duration Announcement by CBF Transmission Invite/Response, for example, by the wireless communications system 100 depicted in FIG. 1, the AP/STA of the multi-link (ML) communications system 200 in a link depicted in FIG. 2, the wireless device 300 depicted in FIG. 3, and/or the sharing AP (AP1) 406-1, the shared AP (AP2) 406-2, the STA (STA1) 410-1, and/or the STA (STA2) 410-2 depicted in FIG. 4 are described.

In some embodiments, a CBF Transmission Invite announces an inviting/sharing AP's ICF/ICR time requirement such that a shared AP can figure out/decide the time when it transmits ICF.

In some embodiments, a CBF Transmission Response announces an invited/shared AP's ICF/ICR time requirement such that a sharing AP can figure out/decide the time when it transmits CBF Sync.

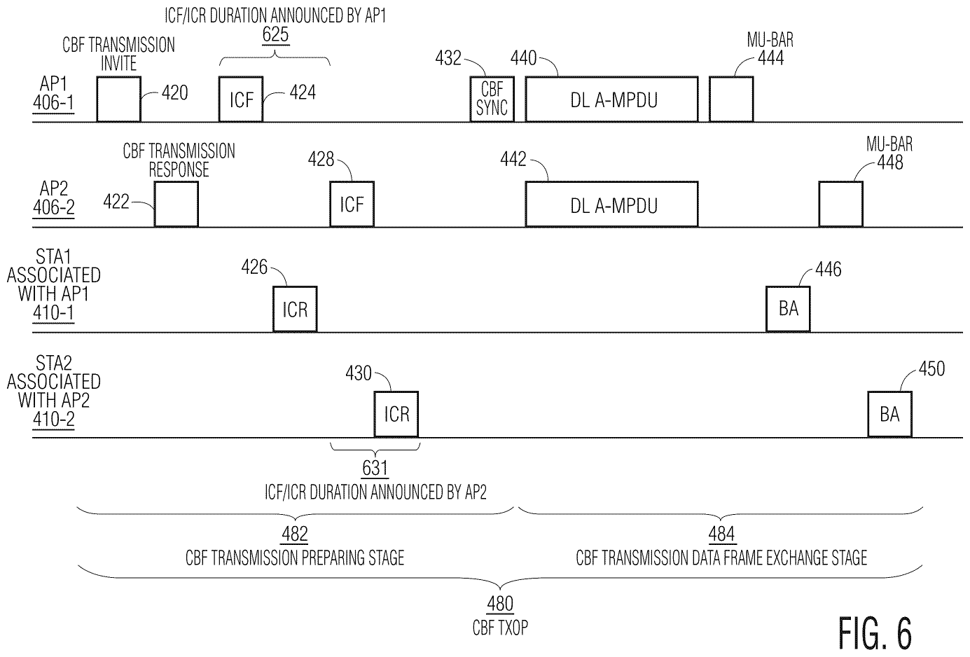

FIG. 6 illustrates some ICF/ICR time requirements 625, 631 set by the sharing AP 406-1 and the shared AP 406-2 in the two-stage CBF TXOP 480 depicted in FIG. 4 in accordance with example embodiments.

In some embodiments, the CBF Transmission Invite 420 announces the inviting/sharing AP (AP1) 406-1's ICF/ICR time requirement/duration 625 such that the shared AP (AP2) 406-2 can figure out the time when it transmits the ICF 428.

In some embodiments, the CBF Transmission Response 422 announces the shared AP (AP2) 406-2's ICF/ICR time requirement/duration 631 such that the inviting/sharing AP (AP1) 406-1 can figure out the time when it transmits the CBF Sync message 432.

In some embodiments, a CBF Sync announces the Acknowledgement exchange time requirement of a sharing AP (e.g., the sharing AP (AP1) 406-1 depicted in FIG. 4), e.g., the sharing AP's MU-BAR, a BA of a station (e.g., the STA (STA1) 410-1 depicted in FIG. 4) associated with the sharing AP, and related Short Interframe Spaces (SIFSs). In some embodiments, in a variant, the CBF Transmission Invite performs such announcement.

In some embodiments, a shared AP (e.g., the shared AP (AP2) 406-2 depicted in FIG. 4)'s MU-BAR announces the Acknowledgement exchange time requirement of the shared AP, e.g. a BA of a station (e.g., the STA (STA2) 410-2 depicted in FIG. 4) associated with the shared AP and related SIFSs. In some embodiments, in a variant, the CBF Transmission Response performs such announcement. In some embodiments, if/when more than one simultaneous DL PPDU transmission with data frames is not allowed, the MU-BAR's announcement is not needed.

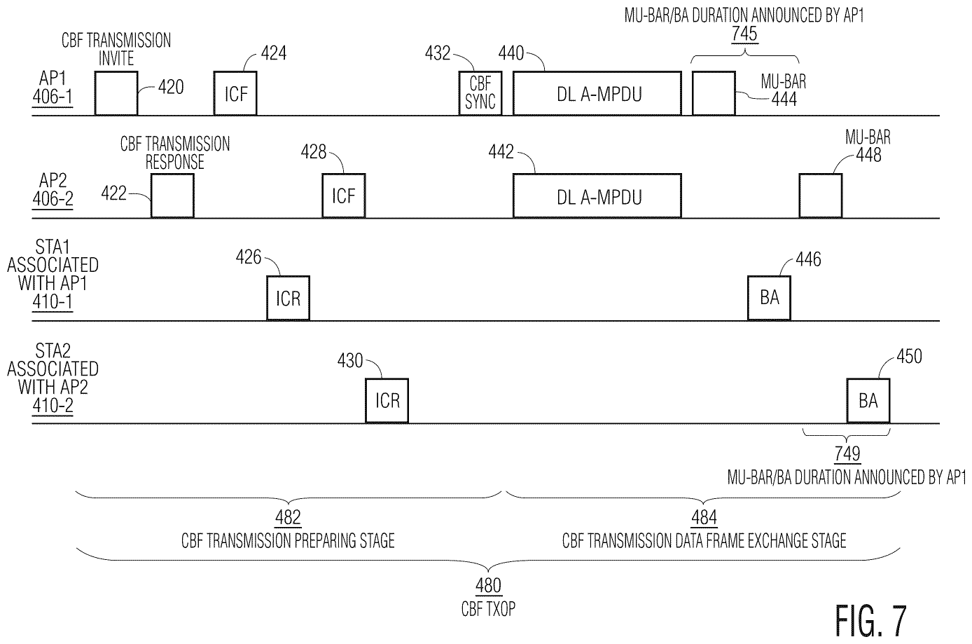

FIG. 7 illustrates some MU-BAR/BA duration announcements 745, 749 by the sharing AP 406-1 and the shared AP 406-2 in the two-stage CBF TXOP 480 depicted in FIG. 4 in accordance with example embodiments.

In some embodiments, the CBF Sync 432 announces the Acknowledgement exchange time requirement/duration requirement 745 of the sharing AP (AP1) 406-1, e.g., the sharing AP (AP1) 406-1's MU-BAR, the STA (STA1) 410-1's BA and related SIFSs. In some embodiments, in a variant, the CBF Transmission Invite 420 performs such announcement.

In some embodiments, the shared AP (AP2) 406-2's MU-BAR announces the Acknowledgement exchange time/duration requirement 749 of the shared AP (AP2) 406-2, e.g., the STA (STA2) 410-2's BA and related SIFSs. In some embodiments, in a variant, the CBF Transmission Response 426 performs such announcement. In some embodiments, if/when more than one simultaneous DL PPDU transmission with data frames is not allowed, the MU-BAR's announcement is not needed.

Some implementations of CBF Transmission Phase-Padding Support in CBF Transmission, for example, by the wireless communications system 100 depicted in FIG. 1, the AP/STA of the multi-link (ML) communications system 200 in a link depicted in FIG. 2, the wireless device 300 depicted in FIG. 3, and/or the sharing AP (AP1) 406-1, the shared AP (AP2) 406-2, the STA (STA1) 410-1, and/or the STA (STA2) 410-2 depicted in FIG. 4 are described.

In some embodiments, in Option 1, each AP (e.g., the sharing AP (AP1) 406-1 and/or the shared AP (AP2) 406-2 depicted in FIG. 4) announce a CBF padding requirement during the CBF negotiation between the two APs for its processing CBF Transmission Invite (as the TXOP responder), processing CBF Transmission Response (as the TXOP holder), processing CBF Sync (as the TXOP responder). In some embodiments, the padding requirement is 0 to 32 microseconds (μs) with the granularity of 4 μs (or 0 to 16 μs with the granularity of 4 μs).

In some embodiments, in Option 2, each AP (e.g., the sharing AP (AP1) 406-1 and/or the shared AP (AP2) 406-2 depicted in FIG. 4) announce three CBF padding requirements during the CBF negotiation between the two APs where one padding requirement is for its processing CBF Transmission Invite (as the TXOP responder), one padding requirement is for processing CBF Transmission Response (as the TXOP holder), and one padding requirement is for processing CBF Sync (as the TXOP responder). In some embodiments, the padding requirement is 0 to 32 microseconds (μs) with the granularity of 4 μs (or 0 to 16 μs with the granularity of 4 μs).

Some implementations of CBF Transmission Prepare Stage-CBF Sync design, for example, by the wireless communications system 100 depicted in FIG. 1, the AP/STA of the multi-link (ML) communications system 200 in a link depicted in FIG. 2, the wireless device 300 depicted in FIG. 3, and/or the sharing AP (AP1) 406-1, the shared AP (AP2) 406-2, the STA (STA1) 410-1, and/or the STA (STA2) 410-2 depicted in FIG. 4 are described.

In some embodiments, in Option 1, a CBF Sync is a BSRP NTB Trigger frame with the reserved bit in a Common Info field or an IEEE 802.11be's Special User Info field being repurposed to indicate the CBF sync purpose. In some embodiments, in another variant, special User Info field(s) whose AID12 field with a value more than 2007 indicates that the BSRP NTB is used as the CBF sync. In some embodiments, in a third option, a new value in a Type field of a Feedback User Info field indicates the BSRP NTB is used as the CBF sync. In some embodiments, such special User Info field(s) carries the parameters for the CBF sync.

In some embodiments, in option 2, a CBF Sync is a multi-user (MU)-Request to send (RTS) frame with the reserved bit in a Common Info field or an IEEE 802.11be's Special User Info field being repurposed to indicate the CBF sync purpose. In some embodiments, in another variant, special User Info field(s) whose AID12 field with a value more than 2007 indicates that the MU-RTS is used as the CBF sync. In some embodiments, in third option, a new value in a Type field of a Feedback User Info field indicates the MU-RTS is used as the CBF sync. Such special User Info field(s) carries the parameters for the CBF sync.

Some implementations of CBF Transmission Prepare Stage-Network allocation vector (NAV) Timer and clear channel assessment (CCA), for example, by the wireless communications system 100 depicted in FIG. 1, the AP/STA of the multi-link (ML) communications system 200 in a link depicted in FIG. 2, the wireless device 300 depicted in FIG. 3, and/or the sharing AP (AP1) 406-1, the shared AP (AP2) 406-2, the STA (STA1) 410-1, and/or the STA (STA2) 410-2 depicted in FIG. 4 are described.

In an observation, a sharing AP (e.g., the sharing AP (AP1) 406-1 depicted in FIG. 4) may set carrier sense (CS) Required in a soliciting BSRP NTB equal to 0, and a shared AP (e.g., the shared AP (AP2) 406-2 depicted in FIG. 4) transmits a DL PPDU with A-MPDU to interfere with its OBSS (Overlapping Basic Service Set) frame exchanges. The shared AP has a NAV timer or an intra-Basic Service Set (BSS) NAV timer and a basic NAV timer. An NAV timer may represent the number of microseconds a transmitter intends to hold the medium busy (e.g., maximum of 32,767 microseconds).

In some embodiments, a sharing AP needs to set CS Required in a soliciting BSRP NTB equal to 1. In some embodiments, a sharing AP needs to set CS Required in a soliciting BSRP NTB equal to 0 or 1.

In some embodiments, if/when a shared AP with an intra-BSS NAV timer and a basic NAV timer receives the BSRP NTB Trigger addressed to it and the CS Required in soliciting BSRP is equal to 1, the shared AP needs to perform the following operations.

In some embodiments, in option 1, if/when neither the intra-BSS NAV timer nor the basic NAV timer has a non-zero value, the shared AP responds with a Multi-STA Block Ack.

In some embodiments, in option 2, if/when the intra-BSS NAV timer has a value of 0 and the basic NAV timer has a value of 0, the shared AP responds with a Multi-STA Block Ack, and if/when the intra-BSS NAV timer has a value of 0 and the basic NAV timer being set by the sharing AP's PPDU has a non-zero value, the shared AP responds with a Multi-STA Block Ack. Otherwise, the shared AP does not send the response.

In some embodiments, if/when a shared AP with one NAV timer receives the BSRP NTB Trigger addressed to it and the CS Required in soliciting BSRP is equal to 1, the shared AP needs to perform the following operations.

In some embodiments, in option 1, if/when the timer has a zero value, the shared AP responds with a Multi-STA Block Ack.

In some embodiments, in option 2, if/when the NAV timer has a value of 0, the shared AP responds with a Multi-STA Block Ack, and if/when the NAV timer being set by the sharing AP's PPDU has a non-zero value, the shared AP responds with a Multi-STA Block Ack. Otherwise, the shared AP does not send the response.

Some implementations of Dynamic Channel Puncture and CBF Operation, for example, by the wireless communications system 100 depicted in FIG. 1, the AP/STA of the multi-link (ML) communications system 200 in a link depicted in FIG. 2, the wireless device 300 depicted in FIG. 3, and/or the sharing AP (AP1) 406-1, the shared AP (AP2) 406-2, the STA (STA1) 410-1, and/or the STA (STA2) 410-2 depicted in FIG. 4 are described.

In some embodiments, in Option 1, the dynamic channel puncture is not allowed in a CBF operation (e.g., a CBF transmission preparing handshake and/or a CBF transmission preparing Synchronization).

In some embodiments, in Option 2, the dynamic channel puncture is allowed in a CBF operation as defined in an IEEE 802.11be protocol. In some embodiments, in ICF and CBF Sync, the channel puncture information is announced.

In some embodiments, a method of conducting or performing CBF operation with a CBF preparing stage and a CBF frame exchange stage among first device 1, first device 2, and two or more than two second devices includes
negotiating, by the first device 1 and the first device 2, whether they establish a CBF agreement through Action frames for CBF negotiation, establishing the CBF group(s) for the CBF frame exchanges;
soliciting, by the first device 1 at a preparing stage, the first device 2 to do the CBF frame exchanges with second devices in a CBF group;
deciding, by the first device 2 at the preparing stage, whether it accepts the request and notifying its decision and sending the responding frame carrying its decision;
sending, by the first device 1 at the preparing stage, the sync frame to synchronize the CBF PPDUs transmitted by the first device 1 and first device 2; and
transmitting, by the first device 1 and first device 2, the CBF PPDUs to the second devices within the CBF group. In some embodiments, the group ID of the CBF group between first device 1 and first device 2 is uniquely identify the CBF group between first device 1 and first device 2 that is defined by the first device 1, first device 2, the second device(s) associated with the first device 1, and the second device(s) associated with the first device 2. In some embodiments, if a frame at the CBF preparing stage triggers the second devices associated with the first device 2 sets its basic NAV timer, the Duration field in the frame needs to indicate ending time no later than the DL PPDU that solicits the responding frame from the second device with the CCA sensing requirement. In some embodiments, the soliciting frame and responding frame indicates whether the transmitter of the frame disables its BSS color usage. In some embodiments, if no first device announces the disabling of its BSS Color, the two first devices transmit a CBF PPDU with TXOP in PHY header equal to a value other than UNSPECIFIED. In some embodiments, if one first device announces the disabling of its BSS Color, the two first devices transmit a CBF PPDU with a TXOP in the PHY header equal to UNSPECIFIED. In some embodiments, if a first device announces the disabling of its BSS Color, the first devices transmit a CBF PPDU with a TXOP in the PHY header equal to UNSPECIFIED, and the other first devices transmit a CBF PPDU with a TXOP in the PHY header equal to a value other than UNSPECIFIED. In some embodiments, if both first devices announce the disabling of its BSS Color, the two first devices transmit CBF PPDU with TXOP in PHY header equal to a value other than UNSPECIFIED. In some embodiments, one first device detects another AP's disabling of its BSS Color through the received Beacon instead of indicating the BSS color collision in CBF transmission invite/response.

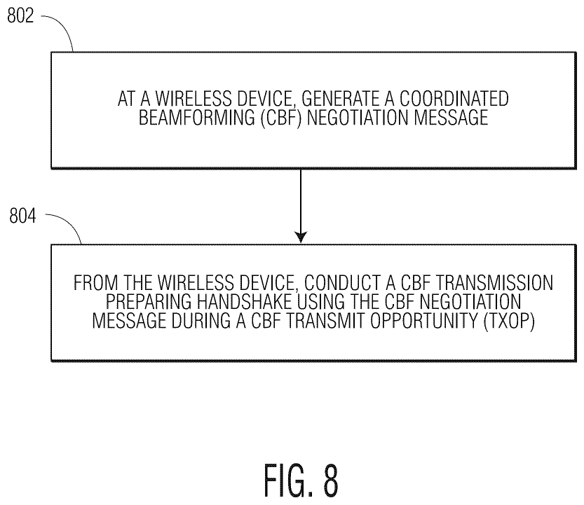

FIG. 8 is a process flow diagram of a method for wireless communications in accordance with an embodiment of the disclosure. At block 802, at a wireless device, a coordinated beamforming (CBF) negotiation message is generated. At block 804, at the wireless device, a CBF transmission preparing handshake is conducted using the CBF negotiation message during a CBF transmit opportunity (TXOP). In some embodiments, the wireless device includes a sharing wireless access point (AP) that shares the CBF TXOP (e.g., share a wireless channel during the CBF TXOP), and the CBF negotiation message includes a CBF transmission invite. In some embodiments, the CBF transmission invite includes a buffer status report poll (BSRP) non-trigger based (NTB) trigger frame, and the BSRP NTB trigger frame contains information indicating that the BSRP NTB trigger frame is used as the CBF transmission invite and CBF transmission parameters information regarding whether the sharing wireless AP performs a polling of an associated wireless station (STA) of the sharing wireless AP. In some embodiments, from the wireless device, the CBF transmission invite is wirelessly transmitted to a shared wireless AP with which the CBF TXOP is shared. In some embodiments, at the wireless device, a CBF transmission response is wirelessly received from the shared wireless AP. In some embodiments, the CBF transmission response contains information indicating that the BSRP NTB trigger frame is used as the CBF transmission invite, and information regarding whether the shared wireless AP performs a polling of an associated wireless station (STA) of the shared wireless AP or information regarding whether the shared wireless AP accepts a CBF frame exchange with the sharing wireless AP. In some embodiments, the CBF transmission response contains information indicating that the shared wireless AP rejects a CBF frame exchange with the sharing wireless AP and information indicating a rejection reason. In some embodiments, the CBF transmission response includes a multi-STA block acknowledgement (Ack) that contains information indicating that the multi-STA block Ack is used as the CBF transmission response. In some embodiments, at the wireless device, an initial control frame (ICF) is generated after the CBF transmission preparing handshake, and from the wireless device, the ICF is wirelessly transmitted to a wireless station (STA) associated with the sharing wireless AP. In some embodiments, at the wireless device, a CBF Synchronization (Sync) message is generated after the CBF transmission preparing handshake, and from the wireless device, the CBF Sync message is wirelessly transmitted. In some embodiments, a dynamic channel puncture is not allowed in a CBF operation. In some embodiments, the wireless device is compatible with an Institute of Electrical and Electronics Engineers (IEEE) 802.11 protocol. In some embodiments, the wireless device includes a wireless multi-link device (MLD), and frame exchanges are conducted with a second wireless MLD through wireless links between the wireless MLD and the second wireless MLD. The wireless device may be the same as or similar to an embodiment of the AP 106 depicted in FIG. 1, the APs 206-1, 206-2 depicted in FIG. 2, the wireless device 300 depicted in FIG. 3, and/or the sharing AP (AP1) 406-1 and/or the shared AP (AP2) 406-2 depicted in FIG. 4.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods described herein may be implemented using software instructions stored on a computer useable storage medium for execution by a computer. As an example, an embodiment of a computer program product includes a computer useable storage medium to store a computer readable program.

The computer-useable or computer-readable storage medium can be an electronic, magnetic, optical, electromagnetic, infrared, or semiconductor system (or apparatus or device). Examples of non-transitory computer-useable and computer-readable storage media include a semiconductor or solid-state memory, magnetic tape, a removable computer diskette, a random-access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Alternatively, embodiments of the disclosure may be implemented entirely in hardware or in an implementation containing both hardware and software elements. In embodiments which use software, the software may include but is not limited to firmware, resident software, microcode, etc.

Although specific embodiments of the disclosure have been described and illustrated, the disclosure is not to be limited to the specific forms or arrangements of parts so described and illustrated. The scope of the disclosure is to be defined by the claims appended hereto and their equivalents.

What is claimed is:

1. A wireless device comprising:
a controller configured to generate a coordinated beamforming (CBF) negotiation message; and
a wireless transceiver configured to conduct a CBF transmission preparing handshake using the CBF negotiation message during a CBF transmit opportunity (TXOP).

2. The wireless device of claim 1, wherein the wireless device comprises a sharing wireless access point (AP) that shares the CBF TXOP, and wherein the CBF negotiation message comprises a CBF transmission invite.

3. The wireless device of claim 2, wherein the CBF transmission invite comprises a buffer status report poll (BSRP) non-trigger based (NTB) trigger frame, and wherein the BSRP NTB trigger frame contains information indicating that the BSRP NTB trigger frame is used as the CBF transmission invite and information regarding whether the sharing wireless AP performs a polling of an associated wireless station (STA) of the sharing wireless AP.

4. The wireless device of claim 2, wherein the wireless transceiver is further configured to wirelessly transmit the CBF transmission invite to a shared wireless AP with which the CBF TXOP is shared.

5. The wireless device of claim 4, wherein the wireless transceiver is configured to wirelessly receive a CBF transmission response from the shared wireless AP.

6. The wireless device of claim 5, wherein the CBF transmission response contains information regarding whether the shared wireless AP performs a polling of an associated wireless station (STA) of the shared wireless AP or information regarding whether the shared wireless AP accepts a CBF frame exchange with the sharing wireless AP.

7. The wireless device of claim 5, wherein the CBF transmission response contains information indicating that the shared wireless AP rejects a CBF frame exchange with the sharing wireless AP and information indicating a rejection reason.

8. The wireless device of claim 5, wherein the CBF transmission response comprises a multi-STA block acknowledgement (Ack) that contains information indicating that the multi-STA block Ack is used as the CBF transmission response.

9. The wireless device of claim 2, wherein the controller is further configured to generate an initial control frame (ICF) after the CBF transmission preparing handshake, and wherein the wireless transceiver is further configured to wirelessly transmit the ICF to a wireless station (STA) associated with the sharing wireless AP.

10. The wireless device of claim 2, wherein the controller is further configured to generate a CBF Synchronization (Sync) message after the CBF transmission preparing handshake, and wherein the wireless transceiver is further configured to wirelessly transmit the CBF Sync message.

11. The wireless device of claim 1, wherein a dynamic channel puncture is not allowed in a CBF operation.

12. The wireless device of claim 1, wherein the wireless device is compatible with an Institute of Electrical and Electronics Engineers (IEEE) 802.11 protocol.

13. The wireless device of claim 1, wherein the wireless device comprises a wireless multi-link device (MLD), and wherein the wireless transceiver is further configured to conduct a plurality of frame exchanges with a second wireless MLD through a plurality of wireless links between the wireless MLD and the second wireless MLD.

14. A method for wireless communications, the method comprising:
at a wireless device, generating a coordinated beamforming (CBF) negotiation message; and
at the wireless device, conducting a CBF transmission preparing handshake using the CBF negotiation message during a CBF transmit opportunity (TXOP).

15. The method of claim 14, wherein the wireless device comprises a sharing wireless access point (AP) that shares the CBF TXOP, and wherein the CBF negotiation message comprises a CBF transmission invite.

16. The method of claim 15, wherein the CBF transmission invite comprises a buffer status report poll (BSRP) non-trigger based (NTB) trigger frame, and wherein the BSRP NTB trigger frame contains information indicating that the BSRP NTB trigger frame is used as the CBF transmission invite and information regarding whether the sharing wireless AP performs a polling of an associated wireless station (STA) of the sharing wireless AP.

17. The method of claim 15, wherein at the wireless device, conducting the CBF transmission comprises from the wireless device, wirelessly transmitting the CBF transmission invite to a shared wireless AP with which the CBF TXOP is shared.

18. The method of claim 17, wherein at the wireless device, conducting the CBF transmission further comprises at the wireless device, wirelessly receiving a CBF transmission response from the shared wireless AP.

19. The method of claim 18, wherein the CBF transmission response contains information regarding whether the shared wireless AP performs a polling of an associated wireless station (STA) of the shared wireless AP or information regarding whether the shared wireless AP accepts a CBF frame exchange with the sharing wireless AP.

20. The method of claim 18, wherein the CBF transmission response contains information indicating that the shared wireless AP rejects a CBF frame exchange with the sharing wireless AP and information indicating a rejection reason.
